(19) United States
(12) Patent Application Publication
(10) Pub. No.: US 2022/0071447 A1
(43) Pub. Date: Mar. 10, 2022

(54) GRILL DEVICE THAT PREVENTS BURNING OF GRILLED FOOD

(71) Applicant: O Hyeok KWON, Pocheon-si (KR)

(72) Inventor: O Hyeok KWON, Pocheon-si (KR)

(21) Appl. No.: 17/423,402

(22) PCT Filed: Jan. 15, 2020
(86) PCT No.: PCT/KR2020/000723

§ 371 Date: Jul. 15, 2021

(30) Foreign Application Priority Data
Jan. 16, 2019 (KR) 10-2019-0005496

(51) Int. Cl. A47J 37/07; A47J 37/06

(52) U.S. Cl. CPC A47J 37/0786; A47J 37/067

(57) ABSTRACT

Disclosed is a grill device that prevents burning of grilled food. The grill device that prevents burning of grilled food according to the present invention prevents, when grilled food such as meat is cooked using solid fuel, melted fat released from the grilled food from dropping directly onto the surface of the solid fuel. Therefore, the grill device can not only prevent the generation of carcinogens produced during burning of melted fat, but can also save fuel by structurally improving the existing grill device that consumes a lot of solid fuel.

### FIELD OF INVENTION

The present invention relates to a grilling device for preventing grilled food from burning, and more particularly to a grilling device for preventing oil secreted from grilled food from falling directly on a surface of solid fuel and saving fuel when cooking.

### BACKGROUND OF INVENTION

When eating meat cooked indoors, it is common to cook and eat meat using an electric grill using electricity or using gas as a heat source. However, because users are capable of avoiding smoke well when meat is cooked in a specialty restaurant or outdoors, rather than indoors in a general house, it is possible to cook meat quickly and well using charcoal or ignited coals.

When meat is cooked using charcoal, the characteristic aroma of charcoal is absorbed into the meat, enhancing the taste of the meat and directly exposing the meat to flame, and thus it is possible to cook the meat in a short time, improving the real taste of the meat.

In order to impart the flavor of charcoal to the meat being cooked, a ventilation hole is formed in a grilling plate on which the meat is placed, or the meat is cooked using a grilling plate having a mesh structure, and thus, it is possible to efficiently apply heat and fragrance emitted from the charcoal to the meat.

However, it is common for meat to secrete a certain amount of oil during cooking, and when the oil drips down below the grilling plate and falls onto the charcoal, incomplete combustion of the charcoal occurs, and in this process, various hazardous substances including carcinogens are scattered around the meat.

It has been pointed out as a serious problem that these hazardous substances are classified as class 1 carcinogens and pollute indoor air or are absorbed into cooked meat and adversely affect people who eat the meat.

To overcome the problem, Korean Patent Publication No. 10-2014-0000916 discloses “Brazier including intermediate plate”.

The conventional brazier basically includes a container for accommodating charcoal therein, a grill part that is positioned above the container and on which food is placed, and an intermediate plate interposed between the container and the grill part.

That is, in order to prevent oil generated when meat is cooked on an upper surface of the grill part from falling directly on charcoal, the intermediate plate is provided between the grill part and the container, and the flavor of charcoal is imparted to cooked meat through a plurality of distribution holes formed in the intermediate plate.

However, the aforementioned conventional brazier is advantageous in that meat oil does not fall directly onto the charcoal, but because fire of the charcoal does not directly contact the meat due to the intermediate plate, it is impossible to cook the meat in a short time, and accordingly, there is a problem that the taste of the cooked meat is not capable of being sufficiently preserved.

### SUMMARY OF INVENTION

### Technical Problem to be Solved

To overcome the problems the Prior art, the present invention provides a grilling device for preventing carcinogens generated when oil is burned from being generated by preventing oil secreted from grilled food from falling directly onto a surface of solid fuel when cooking grilled food such as meat using solid fuel and for also saving fuel by structurally improving an existing grilling device which wastes a lot of solid fuel.

### Technical Solution

According to the present invention, a grilling device for preventing grilled food from burning includes a case having an upper part that is opened, an internal space for accommodating solid fuel therein, and a first oil outlet formed through a center of a bottom surface, a water tank disposed below the first oil outlet and configured to store a predetermined amount of water, a grill shaped like a ring that is mounted on an upper end of the case and having a through hole formed through a center thereof, a fuel support plate shaped like a ring that is mounted on a lower part of the internal space of the case and having an upper surface on which solid fuel is placed and a second oil outlet formed through and connected to the first oil outlet, and a storage basket configured to store the grilled food in a form of a lump and accommodated above the second oil outlet in the internal space of the case.

The grill may include a horizontal plate accommodated on the upper end of the case, and an inclined plate that extends toward a center from the horizontal plate and is inclined downward to allow oil secreted from the grilled food to flow toward a center of an inside of the case.

A mounting groove for mounting a skewer may be formed in an inner circumference of the inclined plate, and a diameter of the second oil outlet may be smaller than a diameter of the through hole.

The storage basket may include a main body formed in a mesh having an opened upper portion and a spacer member provided below the main body to position the main body to be spaced apart from the fuel support plate.

### Effect of Invention

The present invention may have the following effects.

First, the temperature inside a grilling device may be prevented from excessively rising by inducing oil generated from grilled food to fall toward stored water rather than directly falling into solid fuel, steam generated by heat may be applied to the grilled food to prevent the grilled food from being easily dried, and oil dropped from the grilled food may not ignite easily to suppress generation of soot and to also efficiently cook the grilled food without scattering of hazardous substances.

Second, a grill may be formed like a ring corresponding to solid fuel to prevent oil secreted from grilled food from falling directly on solid fuel. Then, the grilled food may be prevented from burning by flame due to incomplete combustion of solid fuel and carcinogens scattered from the solid fuel may be prevented from being generated.

Third, heat may be applied to grilled food in all directions through a storage basket placed around solid fuel to more rapidly cook the grilled food, and also, oil secreted from the grilled food placed in the storage basket may not fall directly on solid fuel, and thus the grilled food may be efficiently cooked without scattering of hazardous substances.

Fourth, a skewer may be fixed to a mounting groove of a grill, and thus separate skewered food may be enjoyed using a storage basket.

### BRIEF DESCRIPTION OF DRAWINGS

FIG. 1 is an overall outer appearance of a grilling device according to the present invention.

FIG. 2 is a diagram showing a schematic exploded configuration of the grilling device shown in FIG. 1.

FIG. 3 is a diagram showing a schematic sectional configuration of the grilling device shown in FIG. 1.

FIG. 4 is a diagram showing an example of a fuel support plate.

FIG. 5 is a diagram showing an example in which a fuel support plate on which a cover is mounted is used.

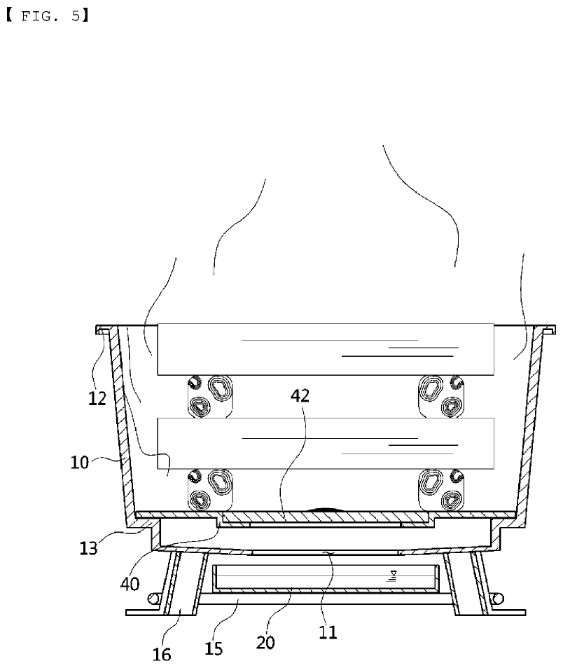

FIG. 6 is a diagram showing an example of a grilling device in which a support leg is not mounted.

FIG. 7 is a diagram showing an example of a grilling device in which a support leg is mounted.

FIG. 8 is a diagram showing an example of a grilling device in which a fuel intake grid is mounted.

FIG. 9 is a diagram showing an example of a solid fuel that is radially divided into a plurality of pieces.

FIG. 10 is a diagram showing an example in which a skewer is mounted in a state in which a grill is removed.

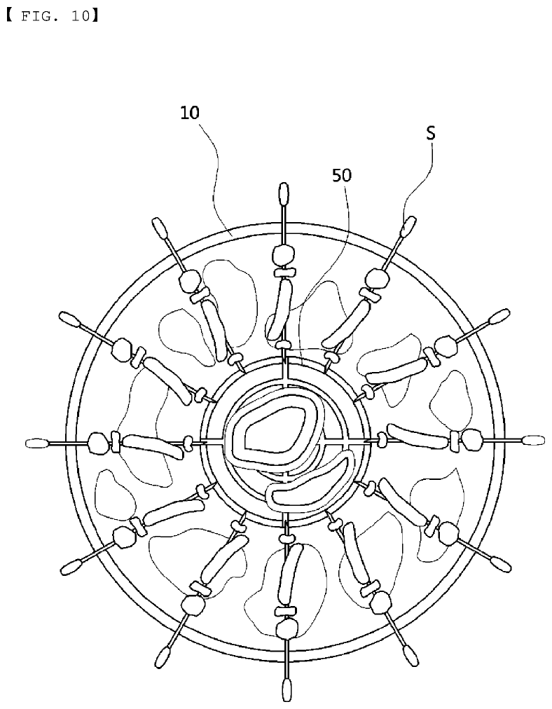

### DESCRIPTION OF REFERENCE NUMERALS

| | |
|---|---|
| 10: case | 20: water tank |
| 30: grill | 40: fuel support plate |
| 50: storage basket | 60: fuel intake grid |
| S: skewer | 11: first oil outlet |
| 12: mount side | 13: step |
| 14: handle | 15: accommodation member |
| 16: mounting part | 17: support leg |
| 18: detachable groove | 31: horizontal plate |
| 32: inclined plate | 33: movement prevention piece |
| 34: mounting groove | 35: Non-slip protrusion |

### BEST MODE

Reference will now be made in detail to embodiments, examples of which are illustrated in the accompanying drawings.

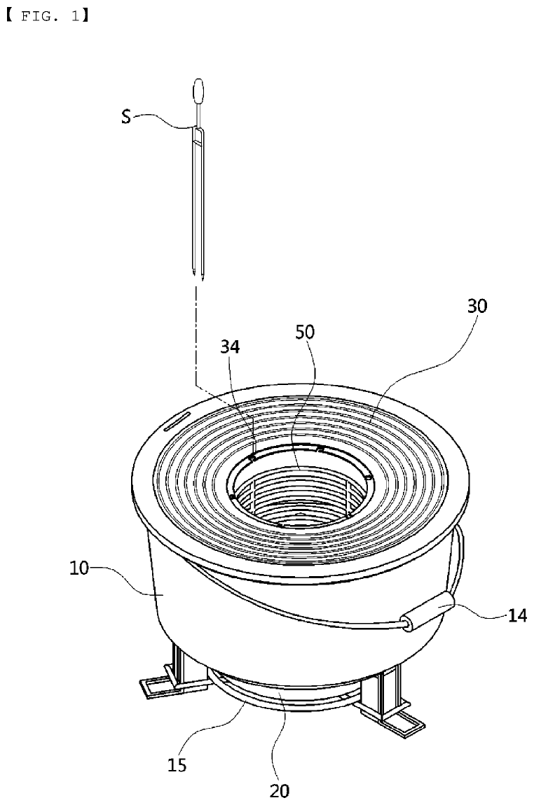

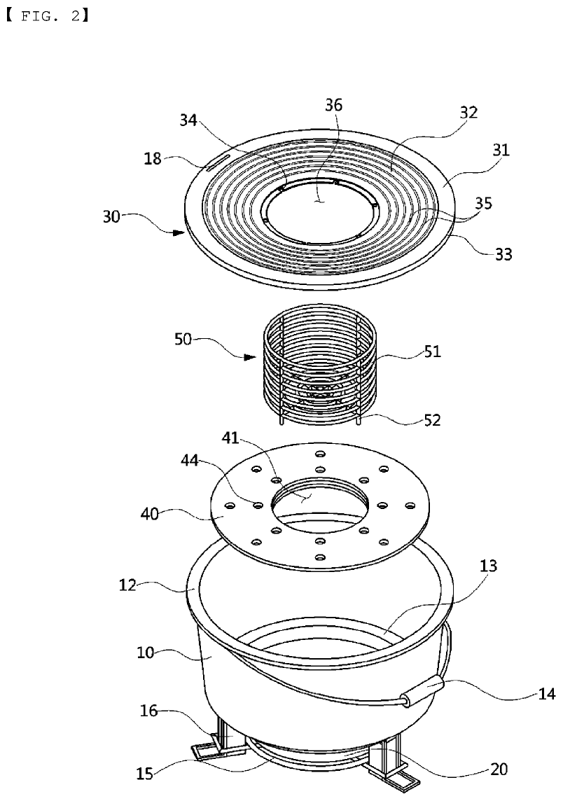

As shown in FIGS. 1 to 3, a grilling device for preventing grilled food from burning according to the present invention may include a case 10 having an upper part that is largely opened, an internal space for accommodating solid fuel therein, and a first oil outlet 11 formed through the center of a bottom surface, a water tank 20 disposed below the first oil outlet 11 and configured to store a predetermined amount of water, a grill 30 shaped like a ring that is mounted on an upper end of the case 10 and having a through hole 36 formed through the center thereof, a fuel support plate 40 shaped like a ring that is mounted on a lower part of the internal space of the case 10 and having an upper surface on which solid fuel is placed and a second oil outlet 41 formed through and connected to the first oil outlet 11, and a storage basket 50 configured to store the grilled food in the form of a lump and accommodated above the second oil outlet 41 in the internal space of the case 10.

In this case, grilled food is a concept that includes all things that are capable of being grilled and eaten, such as meat and fish. In addition, solid fuel may include seeds of various fruits or a material of biomass that is capable of being obtained from surrounding areas, such as sawdust, charcoal, rice husk, coal, and coconut husks.

First, the case 10 may form an overall outer appearance of a grilling device according to the present invention and may accommodate the fuel support plate 40, the storage basket 50, solid fuel, etc. therein. The grill 30 may be mounted on the upper end of the case 10, and the water tank 20, support legs 17 to be described later may be installed below the case 10.

A handle 14 for lifting the grilling device may be provided outside the case 10, and as necessary, an air inlet for injecting air to the inside may be formed through the case 10. A mount side 12 for mounting the grill 30 may be formed on the upper end of the case 10.

The mount side 12 may be bent a plurality of times to reinforce the case 10 as well as to support the grill 30.

The case 10 may be formed of stainless steel, porcelain, etc. to improve heat dissipation.

The case 10 may be formed in a cylindrical shape but it is obvious that the case 10 may be modified and implemented in various ways in addition to the cylindrical shape.

A step 13 may be formed at a lower part of the internal space of the case 10 to provide a part for mounting the fuel support plate 40. A gradient that is inclined downward toward the center of a lower surface of the case 10, and the first oil outlet 11 may be formed through the center of the lower surface. Oil generated from the grilled food may flow along the lower surface of the case 10 and may be discharged outside the case 10 toward the first oil outlet 11.

The oil discharged to the outside of the case 10 may be collected in the water tank 20 placed directly below the case 10.

Although not shown, an inner circumferential surface of the case 10 may be surrounded by an insulating member. In this case, the insulating member may be accommodated on the fuel support plate 40 in the form of a ring divided into two pairs.

When the insulating member is positioned on the inner circumferential surface of the case 10, solid fuel may be prevented from directly contacting an inner wall of the case 10. When the solid fuel comes into contact with the inner wall of the case 10, there may be a risk that an ambient temperature of the case 10 rises and a user is burned. The insulating member may be formed of a material with excellent insulation and heat resistance, such as ceramics, and heat of a charcoal piece may stay sufficiently inside the case 10, thereby maximizing efficiency of thermal energy.

An accommodation member 15 for mounting the water tank 20 may be formed below the case 10, and mounting parts for detachably mounting the support legs 17 on the accommodation member 15 may be radially formed.

When high-temperature oil generated from the grilled food falls toward the water stored in the water tank 20, the oil may be instantaneously cooled to prevent the ambient temperature of the case 10 from rising and may suppress smoke generated when oil comes into contact with the surface of the metal.

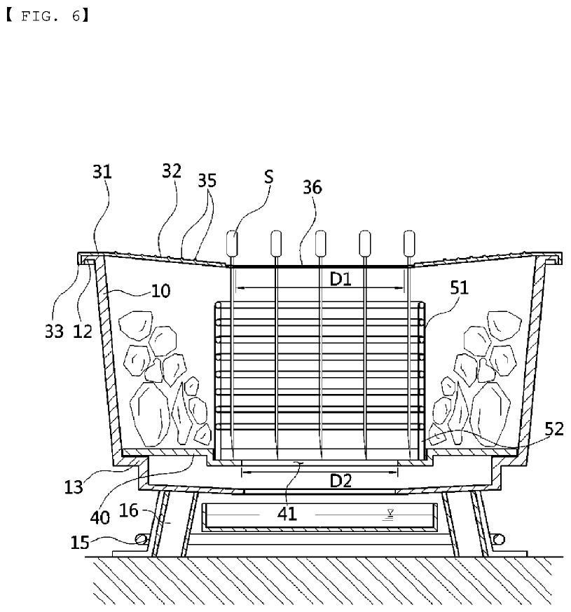

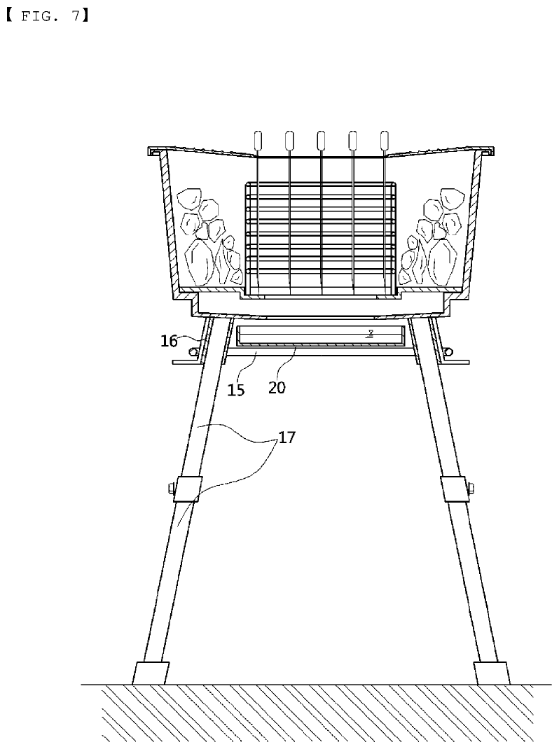

As shown in FIG. 6, when the support legs 17 are not used, the grilling device may be used in the state in which the accommodation member 15 is supported on the ground, and as shown in FIG. 7, when the support legs 17 are mounted on the mounting parts 16 as necessary, the grilling device may be used while the case 10 itself is spaced apart from the ground. In addition, the support legs 17 may be configured to be extensible, and for example, the plurality of support legs 17 may be installed one after another or may be configured in the form of an extendable and collapsible antenna structure. That is, the grilling device according to the present invention may be configured to adjust the height of the case 10 as necessary.

Then, the grill 30 may have the same ring shape as a shape of the case 10 for accommodating solid fuel to discharge oil secreted from the grilled food toward the center of the inside of the case 10 rather than falling directly on the solid fuel by exposing the grilled food to heat dissipated from the solid fuel.

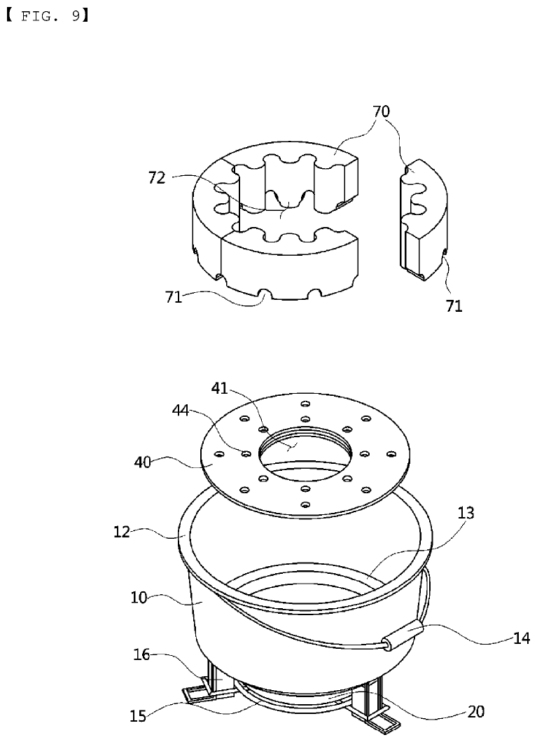

In addition to the aforementioned solid fuel, as shown in FIG. 9, the solid fuel may be formed like a ring through which fluid flow holes 71 are formed to allow air to circulate inside and may include unit heat sources 70 that are radially separated from each other and are positioned adjacent to each other and a hollow 72 formed inside.

That is, the solid fuel may be arranged in the form of a ring inside the case 10 or may have a ring shape per se, and the grill 30 may be provided to correspond to the shape of the solid fuel, and thus oil secreted from the grilled food placed on the grill 30 may fall only toward the hollow of the solid fuel rather than falling directly on a surface of the solid fuel.

In more detail, the grill 30 may be defined as including a horizontal plate 31 accommodated on the upper end of the case 10 and an inclined plate 32 that extends toward the center from the horizontal plate 31 and is inclined downward to allow oil secreted from the grilled food to flow toward the center of the inside of the case 10.

The grilled food placed on the grill 30 may indirectly receive heat of the solid fuel, and thus may be maintained in a heating state suitable for ingestion. In addition, oil secreted from the grilled food placed on the grill 30 may flow along the inclined plate 32 and may be discharged out of the first oil outlet 11 through the center of the case 10.

A detachable groove 18 into which an end of a tool for lifting the grill 30 is inserted may be concavely formed in the grill 30. The detachable groove 18 may be formed on an upper surface of any one of the horizontal plate 31 and the inclined plate 32 and may be completely formed through the grill 30.

When the grill 30 is raised in order to replace the grill 30 or the solid fuel, the grill 30 heated to high temperature may be easily treated by inserting the tool into the detachable groove 18 and lifting the grill 30.

In addition, the grill 30 may further include a movement prevention piece 33 that extends downward from the outside of the horizontal plate 31 in a vertical direction. In this case, the movement prevention piece 33 may hermetically contact a circumference of the upper end of the case 10, especially the mount side 12 to prevent the grill 30 from being moved.

Next, the fuel support plate 40 may be a plate-shaped member and may be accommodated on the step 13 to support the solid fuel accommodated in the case 10 from below. An air inlet 44 through which air passes around the second oil outlet 41 may be formed through the fuel support plate 40

The grilling device according to the present invention may be used for the same purposes as a stove in addition to cooking grilled food. In this case, the grilling device may be used as a stove after removing the grill 30 from the case 10, stacking dry firewood on the fuel support plate 40, and igniting the dry firewood.

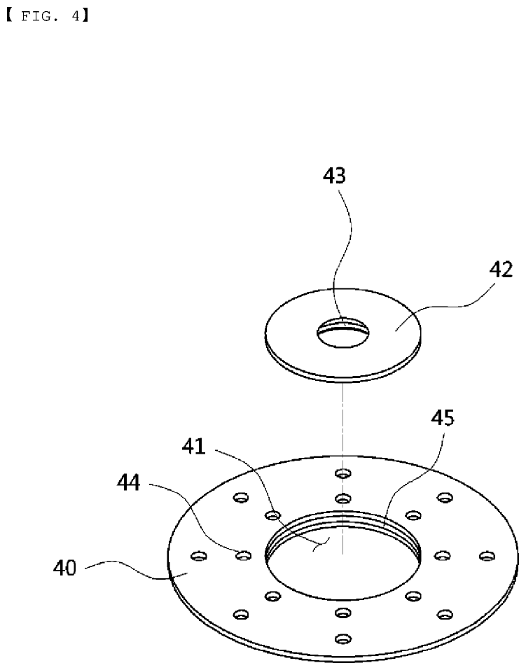

In addition, as shown in FIG. 4, a cover 42 for opening and closing an opened portion of a second oil discharge hole 41 may be detachably coupled to the fuel support plate 40, and the cover 42 may include a gripping piece 43 that is formed like a plate at the center, prevents ashes of the firewood placed on the fuel support plate 40 from falling into the water tank 20, and is configured to lift the cover 42.

When the firewood placed on the fuel support plate 40 is partially burned, firewood pieces may be pushed to and arranged at a circumference side, the cover 42 may be lifted and removed, and then the storage basket 50 may be mounted toward the center of the fuel support plate.

Then, the storage basket 50 may be accommodated above the fuel support plate 40 and may accommodate the grilled food therein in the form of a lump or may accommodate a skewer S for skewered food.

When the storage basket 50 is placed inside the case 10, solid fuel is placed directly around the storage basket 50, and thus when the grilled food is placed inside the storage basket 50, heat may be applied to the grilled food in all directions to more rapidly cook the grilled food, and also, oil secreted from the grilled food placed in the storage basket 50 does not fall directly on solid fuel, and thus the grilled food may be efficiently cooked without scattering of hazardous substances.

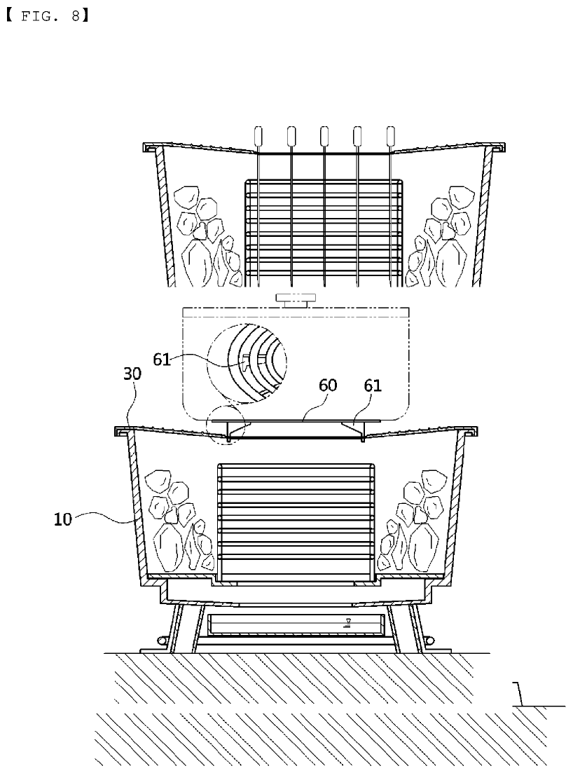

The skewer S may be placed vertically inside the storage basket 50, and in this case, mounting grooves 34 for mounting the skewer S may be formed in an inner circumference of the inclined plate 32 in order to support the skewer S. The plurality of mounting grooves 34 may be installed one after another and may also be used as a mounting device for mounting the fuel intake grid 60 as shown in FIG. 8.

When the skewer S with grilled food is inserted into and fixed to the mounting grooves 34, the skewer S may cross the inside of the storage basket 50 and a lower end of the skewer S may be in contact with the fuel support plate 40, thereby stably maintaining the skewer S.

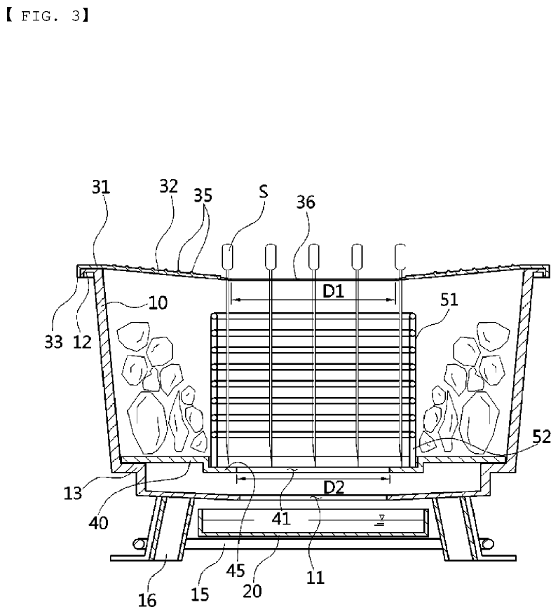

To this end, as shown in FIG. 3, a diameter D2 of the second oil outlet 41 may be smaller than a diameter D1 of the through hole 36 of the grill 30. By virtue of this configuration, when the skewer S is inserted into and fixed to the mounting grooves 34, the lower end of the skewer S may contact an upper surface of the fuel support plate 40 to be stably supported rather than passing through the second oil discharge hole 41.

A step difference 45 that is stepped downward may be formed around the second oil outlet 41 of the fuel support plate 40 and the lower end of the skewer S may contact the step difference 45. Then, oil generated from the grilled food inserted into the skewer S may be smoothly discharged out of the second oil outlet 41 rather than being introduced toward the solid fuel.

Non-slip protrusions 35 may protrude in a circumferential direction on an upper surface of the inclined plate 32 and may prevent the grilled food placed on the inclined plate 32 from slipping toward the through hole 36 of the grill 30.

The storage basket 50 may be defined as including a main body 51 formed in a mesh having an opened upper portion and a spacer member 52 provided below the main body 51 to position the main body 51 to be spaced apart from the fuel support plate 40.

The main body 51 may be spaced apart from the fuel support plate 40 by the spacer member 52, and thus oil discharged from the main body 51 may be prevented from being collected on the fuel support plate 40 and catching fire.

As shown in FIG. 8, the grilling device according to the present invention may further include the fuel intake grid 60. The fuel intake grid 60 may be mounted on a central portion of the grill 30 and may include a plurality of lattice protrusions 61 protruding from a lower surface of the fuel intake grid 60. In this case, the lattice protrusions 61 may be coupled to the mounting grooves 34 to couple the grill 30 and the fuel intake grid 60 to each other, thereby receiving heat discharged from solid fuel without change.

The grilling device may be used for a kitchen tool such as a pan or a pot on an upper part of the fuel intake grid 60 or for cooking grilled food directly.

In summary, the grilling device according to the present invention may prevent oil secreted from the grilled food from falling directly on the surface of the solid fuel even if the grilled food secretes oil, and thus may prevent the grilled food from burning by flame due to incomplete combustion of solid fuel and may prevent carcinogens scattered from the solid fuel from being generated.

Heat may be applied to the grilled food in all directions through the storage basket 50 to more rapidly cook the grilled food, and also, oil secreted from the grilled food placed in the storage basket 50 may not fall directly on solid fuel, and thus the grilled food may be efficiently cooked without scattering of hazardous substances.

The embodiments of the present invention described above are merely exemplary, and those of ordinary skill in the art to which the present invention pertains will appreciate that various modifications and equivalent other embodiments are possible therefrom. Accordingly, it will be well understood that the present invention is not limited to the forms recited in the above detailed description. It is also to be understood that the present invention includes all modifications, equivalents and substitutions falling within the spirit and scope of the invention as defined by the appended claims.

1. A grilling device for preventing grilled food from burning, the grilling device comprising:
a case having an upper part that is opened, an internal space for accommodating solid fuel therein, and a first oil outlet formed through a center of a bottom surface;
a water tank disposed below the first oil outlet and configured to store a predetermined amount of water;
a grill shaped like a ring that is mounted on an upper end of the case and having a through hole formed through a center;
a fuel support plate shaped like a ring that is mounted on a lower part of the internal space of the case and having an upper surface on which solid fuel is placed and a second oil outlet formed through and connected to the first oil outlet; and
a storage basket configured to store the grilled food in a form of a lump and accommodated above the second oil outlet in the internal space of the case.

2. The grilling device of claim 1, wherein the grill includes:
a horizontal plate accommodated on the upper end of the case; and
an inclined plate that extends toward a center from the horizontal plate and is inclined downward to allow oil secreted from the grilled food to flow toward a center of an inside of the case.

3. The grilling device of claim 2, wherein a mounting groove for mounting a skewer is formed in an inner circumference of the inclined plate.

4. The grilling device of claim 1, wherein a diameter of the second oil outlet is smaller than a diameter of the through hole.

5. The grilling device of claim 1, wherein the storage basket includes a main body formed in a mesh having an opened upper portion and a spacer member provided below the main body to position the main body to be spaced apart from the fuel support plate.
